(19) United States
(12) Patent Application Publication
(10) Pub. No.: US 2011/0139481 A1
(43) Pub. Date: Jun. 16, 2011

(54) Brick Box

(76) Inventor: Perrin Kunath, North Richland Hills, TX (US)

(21) Appl. No.: 12/816,174

(22) Filed: Jun. 15, 2010

Related U.S. Application Data
(60) Provisional application No. 61/187,207, filed on Jun. 15, 2009.

(51) Int. Cl. H02G 3/08

(52) U.S. Cl. 174/50

(57) ABSTRACT

Embodiments of the present disclosure generally provide an electrical connection box for use in structures with a brick or stone veneer along a frame.

This application claims benefit under 35 U.S.C. §119(e) of U.S. Provisional patent application Ser. No. 61/187,207 filed on Jun. 15, 2010 in the United States Patent and Trademark Office, entitled “Brick Box.” The entire disclosure of U.S. Provisional Patent Application Ser. No. 61/187,207 is incorporated herein by reference, as if fully disclosed herein.

The disclosure relates generally to electrical connection boxes used in the construction industry, and in particular to electrical connection boxes used in walls with brick or stone veneers.

### BACKGROUND

Electrical connection boxes are used to protect the connections between wiring and fixtures and isolate those connections from the structure as well as the elements. Typical electrical connection boxes are rectangular or circular with knockouts for wire to be run into the box and tabs for securing the box to the frame of the structure being built.

A shortcoming of boxes being used today is that when a brick veneer is applied over a building frame the box must be placed flush with the brick veneer and then a conduit must be attached to the box and run to the area between the framing members. The attachment of conduit to a typical electrical connection box is not takes time and often ends up in destroying the electrical connection box if the material is weak or the contractor makes any of several small errors while making the connection.

It would be advantageous to have an electrical connection box formed with the necessary conduit such that no modification is need for mounting the electrical connection box in the brick or stone veneer of a building during construction.

### SUMMARY

Embodiments of the present disclosure generally provide an electrical connection box for use in structures with a brick or stone veneer along a frame.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is a side view of a round brick box;

FIG. 2 is a front view of a round brick box;

FIG. 3 is a top view of a rectangular brick box;

FIG. 4 is a side view of a rectangular brick box;

FIG. 5 is a front view of a rectangular brick box; and

FIG. 6 is a cutaway view of a wall with a rectangular brick box installed.

### DETAILED DESCRIPTION

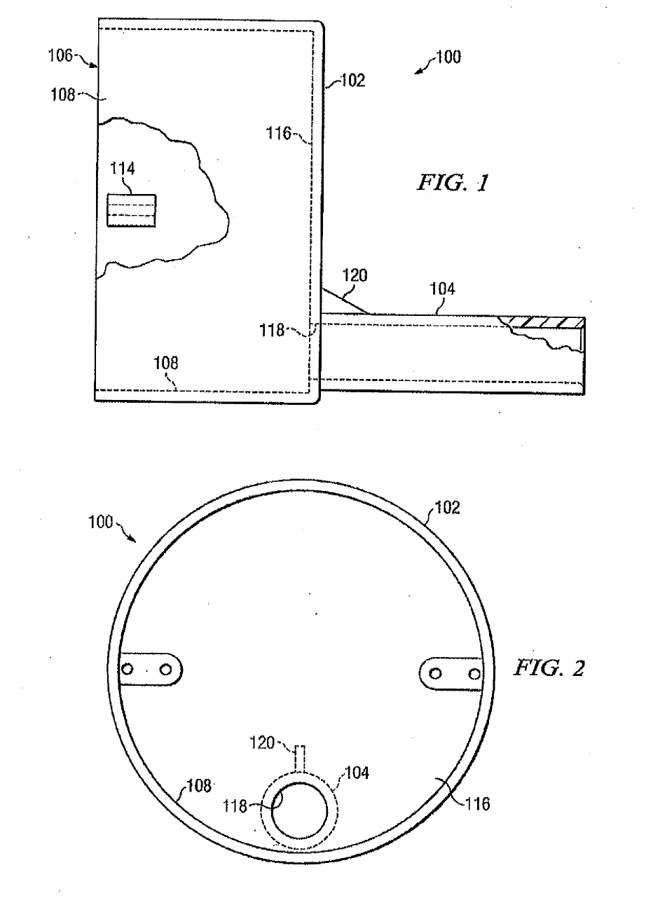

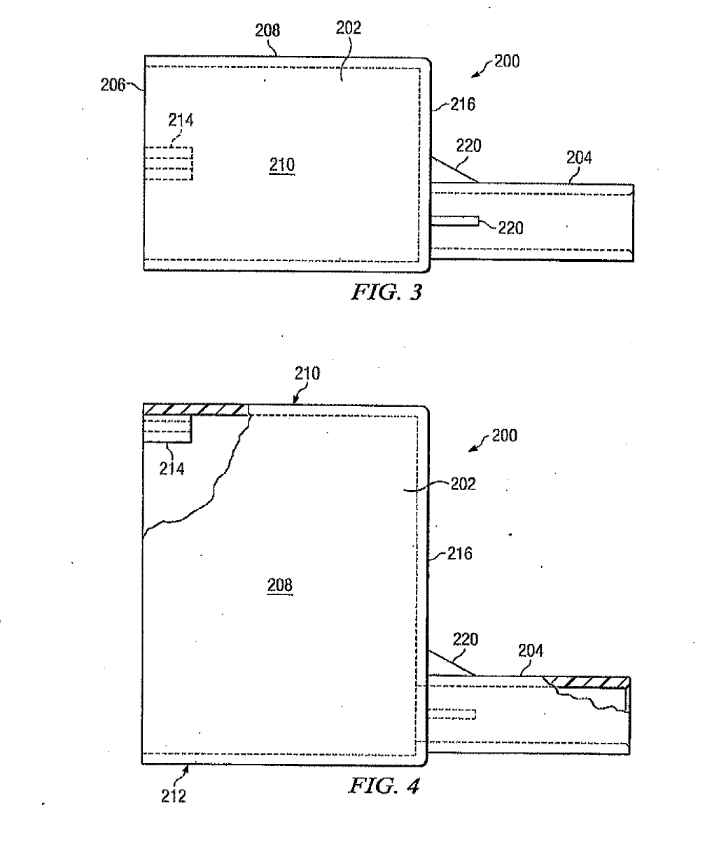

The present disclosure generally provides for an electrical connection box for use in walls with a brick or stone veneer over a framed wall. Two examples are shown in detail, a round version in FIGS. 1 and 2 and a rectangular version in FIGS. 3 through 6.

FIG. 1 is a side view of a round brick box 100 having a body 102 and a conduit 104. Body 102 has a front opening 106 defined by a wall 108 around the circumference of the opening with fixture tabs 114 placed on the inner surface of the wall 108. Wall 108 attaches to rear 116 to complete the body 102. Rear 116 has a hole 118 that allows for wires to pass from conduit 104 into body 102. Conduit 104 is attached to rear 116 and flange 120 reinforces the connection.

The whole of brick box 100 may be molded of a single material such as any of a number of plastics commonly used for electrical connection boxes. It is thought that such a molded brick box 100 would reduce the costs of installing electrical fixtures in brick or stone veneer walls by a significant amount. Conduit may also be secured by other manufacturing means such as thermo plastic welding or chemical adhesives.

FIG. 2 is a front view of a round brick box 100 having a body 102 and a conduit 104 as discussed above. Clearer from this view are tabs 114 along wall 108 for securing an electrical fixture (not shown) to the brick box. Also the placement of hole 118 and the alignment of conduit 104 on rear 116 is more evident form this perspective.

FIG. 3 is a top view of a rectangular brick box 200 having a body 202 and a conduit 204. Body 202 has a front opening 206 defined by sides 208, a top 210, and a bottom 212. Sides 208, top 210 and bottom 212 are all attached to rear 216. Fixture attachment tabs 214 are in top 210 and bottom 212. Rear 216 has a hole 218 aligned with conduit 204 to allow passage of wire from conduit 204 into body 202. Flanges 220 help to support the connection between body 202 and conduit 204.

FIG. 4 is a side view of a rectangular brick box 200 showing side 208 and the alignment of conduit 204 with body 202. Clearer from this view is the position of flanges 220 around the intersection of conduit 204 and body 202.

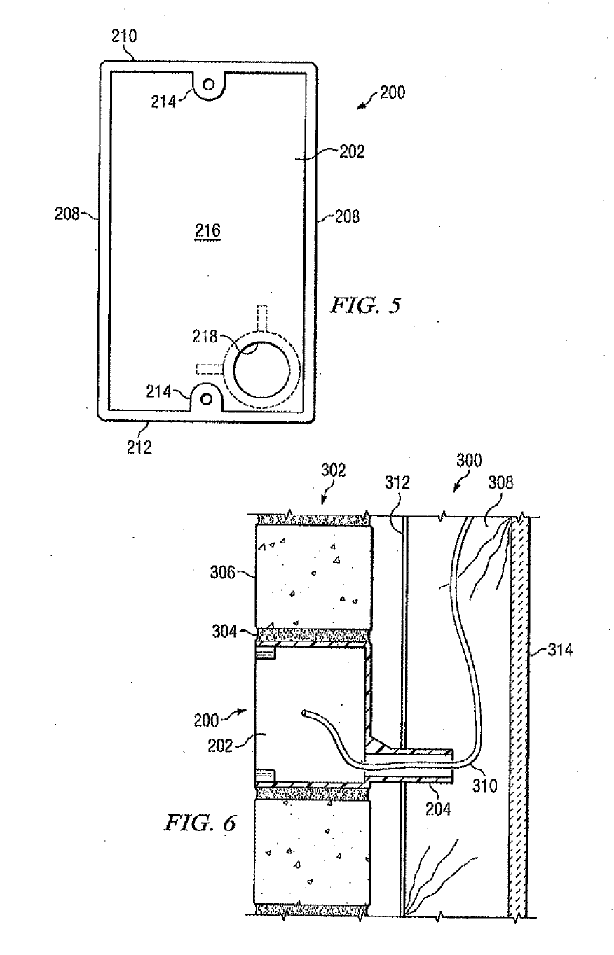

FIG. 5 is a front view of a rectangular brick box 200 showing the front opening of body 202 and the position of conduit 204 along the rear 216 at hole 218. Fixture tabs 214 are also shown along top 210 and bottom 212 for securing a fixture (not shown) to brick box 200.

The whole of brick box 200 may be molded of a single material such as any of a number of plastics commonly used for electrical connection boxes. It is thought that such a molded brick box 200 would reduce the costs of installing electrical fixtures in brick or stone veneer walls by a significant amount. Conduit may also be secured by other manufacturing means such as thermo plastic welding or chemical adhesives.

FIG. 6 is a cutaway view of a wall 300 with a rectangular brick box 200 installed in the brick veneer 302 of wall 300. As shown, mortar 304 and bricks 306 secure body 202 such that conduit 204 is allowed to extend towards frame 308 clear of bricks 306 and mortar 304. Conduit 204 allows wire 310 to extend from frame 308 to an exterior surface of brick veneer 302 without interference. Conduit 204 passes through sheathing 312, if present between brick veneer 302 and frame 308. Wallboard 314 is on the interior of frame 308.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An electrical connection box for use in a veneer wall having:
a body with a circular front opening, the front opening defined by a wall about the circumference of the front opening, and a rear opposite the front opening and joined to the wall, the rear having a hole; and
a conduit aligned with the hole and integrated into the rear.

2. The electrical connection box of claim 1 further comprising a flange to support the conduit in connection with the rear.

3. The electrical connection box of claim 1 further comprising fixture attachment tabs integrated into the wall.

4. The electrical connection box of either claim 1 being formed of a single piece of material.

5. The electrical connection box of claim 4 wherein the material is plastic.

6. An electrical connection box for use in a veneer wall having:
a body with a rectangular front opening defined by side walls, a top and a bottom, and a rear opposite the front opening and secured to the side walls, top and bottom, the rear having a hole; and
a conduit aligned with the hole and integrated into the rear.

7. The electrical connection box of claim 6 further comprising flanges to support the conduit in connection with the rear.

8. The electrical connection box of claim 6 further comprising fixture attachment tabs integrated into the top and bottom of the body.

9. The electrical connection box of either claim 6 being formed of a single piece of material.

10. The electrical connection box of claim 9 wherein the material is plastic.
